(19) United States
(12) Patent Application Publication
(10) Pub. No.: US 2008/0220798 A1
(43) Pub. Date: Sep. 11, 2008

(54) MECHANISM TO FACILITATE CUSTOMIZATION OF REAL TIME MESSAGING USING MOBILE DEVICES

(75) Inventors: Lakshmi POTLURI, Scottsdale, AZ (US); Kiran Sattiraju, San Jose, CA (US)

Correspondence Address: SAWYER LAW GROUP LLP, 2465 E. Bayshore Road, Suite No. 406, PALO ALTO, CA, 94303, US

(73) Assignee: INTERNATIONAL BUSINESS MACHINES CORPORATION, Armonk, NY (US)

(21) Appl. No.: 12/126,124

(22) Filed: May 23, 2008

Related U.S. Application Data
(63) Continuation of application No. 11/012,028, filed on Dec. 14, 2004.

(51) Int. Cl. H04Q 7/20

(52) U.S. Cl. 455/466

(57) ABSTRACT

A customized messaging system facilitates customization of text messaging using mobile devices. The customized messaging system converts user-defined, customized shortcuts into full text equivalents for sending and receiving messages. The present system allows a user to enter a message using key entry shortcuts for character strings or phrases that may have meaning only to the user while sending a full text version of the message to a message recipient. A user may modify the presentation of the message depending on the recipient; i.e., a business colleague or employer can receive a more formal, full text message while a friend or family member receives a more casual message with some of the shortcuts replaced. The customized message system modifies text in an incoming message, selecting shortcuts for text equivalents according to a pre-defined profile supplied by the user. The incoming message viewed by the user thus uses shortcuts defined by the user.

### CROSS-REFERENCE TO RELATED APPLICATIONS

This Under 35 USC §120, this application is a continuation application and claims the benefit of priority to U.S. patent application Ser. No. 11/012,028, filed Dec. 14, 2004, entitled “Mechanism To Facilitate Customization Of Real Time Messaging Using Mobile Devices”, all of which is incorporated herein by reference.

### FIELD OF THE INVENTION

The present invention relates generally to communication between network devices, and particularly to a system of customized real time messaging among the networked mobile devices. More specifically, the present invention pertains to a system for translating user-defined shortcut character strings to customized text equivalents.

### BACKGROUND OF THE INVENTION

Communication technology has transformed from predominantly wire-based networks to wireless networks. With the advent of modern technological innovations, communication devices have become smaller and at the same time “smarter”. These smart wireless devices diverge from traditional models and means of communication for text messaging, emails, etc., and comprise sufficient computer processing capability to function as digital portable terminals. A function known as a Short Message Service (SMS) allows digital portable terminals (e.g., mobile phones, PDAs, Laptop Computers, etc.) to transmit or receive text messages. To this end, the digital portable terminals (i.e., user terminals) are configured in such a way to write, edit, and transfer the text messages.

Text messages can originate from various sources, in various ways, including dialing a toll free number to reach an operator who keys in the message and sends the keyed message directly to a user terminal. An SMS communication is not “real time”, that is, messages are exchanged independently of each other, and as such, SMS communication does not require the establishment of a simultaneously contiguous end-to-end traffic path. A typical SMS system includes user terminals as the initiators or final destinations for messages, a Short Message Service Center (SMSC) that serves as a relay for messages among terminals through the network, and the network itself serving as the communications medium for the messages. Final destinations for messages are not limited to user terminals and may comprise, for example, e-mail addresses, pagers, and fax machines. The Short Message Transfer Protocol (SMTP), in addition to various lower layer protocols, manages the transfer of messages among terminals.

Conventional SMS function, however, has a downside in that the capacity to transfer a text message is limited by the amount of data that can be processed by the SMS function. Thus, users are only allowed to transfer a specified length of a text message allowed by the system. In the event that a user wishes to transmit a relatively long text message that exceeds the allowable frame length under the SMS function, the user has to divide the long text message into a plurality of short messages and then manually transmit each divided message one by one.

As wireless devices become more and more common, there is an increasing need to make such devices operate efficiently in text messaging mode. Currently, most Personal Communication Services (PCS) phones offer a text message editing, transmitting, and receiving capabilities, wherein a short message is sent and received from the PCS phone. A number of mobile devices are pure text devices that are equivalent to a sophisticated pager and able to originate text messages. Most mobile devices have a small form factor, requiring either a keyboard with a reduced set of characters or a shrunken computer keyboard. Consequently, the act of keying in meaningful phrases is vastly more difficult than with a standard computer keyboard. Furthermore, most phone users are accustomed to keying in numbers rather than text using a single hand.

Although the use of email and other messaging services from the smart wireless devices has become ubiquitous, there currently exist no standards or conventions to integrate user preferences for exchanging text messages. The lack of uniform standards in defining the form factor, design and the shape of the interface of a pervasive device allows the manufacturers wide latitude in design. However, this creates text entry difficulties for users, be it for an email, text message, or notes.

To overcome the difficulty of typing long text messages on mobile devices, many users have adopted personal shortcuts to words of common use. For example, a user may use “mtg” as a shortcut for “meeting”, “bfn” as a shortcut for “bye for now”, “bz” as a short cut for “busy”, and “l8r” as a shortcut for “later”. However, there are no universal standards for these shortcuts. The receiver of a message may not understand a shortcut that the message sender uses in a text message. Further, shortcuts acceptable for personal use may be present a bad impression in a text message intended for a professional or business purpose. Furthermore, user preferences (e.g., font, color, language, etc.) of the sender may not be acceptable to the receiver.

Methods, such as the one disclosed in U.S. Pat. No. 6,473,621 by Anders Heie, are provided to detect shortcuts defined by a user within a message, and to replace them with a corresponding strings of text previously stored in memory before transmitting it to a receiver. Although this technology has proven to be useful, it would be desirable to present additional improvements. Conventional techniques do not determine if the recipient of the expanded text message is able to receive it in its entirety, nor do they present the text messages to the receiver using the preferences and shortcuts of the recipient.

What is therefore needed is a system and a computer program product which enable the users to send text messages using their personalized shortcuts and user preferences, and to receive text messages using the personalized shortcuts and user preferences of the receiver rather than the preferences of the sender. The need for such a solution has heretofore remained unsatisfied.

### SUMMARY OF THE INVENTION

The present invention satisfies this need, and presents a system and a computer program product (collectively referred to herein as “the system” or “the present system”) for facilitating customization of text messaging using mobile devices. The present system converts user-defined, customized shortcuts into full text equivalents for sending and receiving messages.

The present system further allows a user to enter a message using key entry shortcuts for words or phrases that may have meaning only to the user while sending a full text version of the message to the message recipient. Consequently, a user may modify the presentation of the message depending on the recipient; i.e., a business colleague or employer can receive a more formal, full text message with most or all of the shortcuts replaced while a friend or family member receives a more casual message with some of the shortcuts replaced.

The present system allows the user to define profiles such as home, work, friends, etc. Within each of the profile, the user creates text shortcuts that are assigned to each profile. For example, a user may use the shortcut “bfn” to mean “bye for now” and assign a text equivalent “bye for now” to the shortcut “bfn” for profiles such as friends and family. The term text equivalent is used to describe a replacement for the shortcut defined by the user that comprises words or a combination of words and shortcuts. However, the user may assign a more formal text equivalent such as “goodbye” or “sincerely” to the same shortcut “bfn” for a profile such as a work profile. The present system sends text that meets the formality desired by the user for the recipient without any modification of text entry on the part of the user.

In one embodiment, the present system modifies text received by the user in an incoming message. The present system selects shortcuts for text equivalents found in the incoming message according to a pre-defined profile supplied by the user. The incoming message viewed by the user thus uses shortcuts defined by the user. The present system allows a user to conserve viewing space on small text screens such as those on mobile devices without using unfamiliar shortcuts or acronyms. The user may optionally enable the present system for either sending messages or receiving messages.

The present system operates on a mobile messaging device. In one embodiment, the present system operates on a server cluster used for managing communications such as instant messaging, e-mail, etc. An Internet service provider may use such a server cluster. The present system operating on a server cluster can convert text equivalents to shortcuts in incoming messages or shortcuts to text equivalents in outgoing messages as a service for users. The service may be performed free, for a fee, or as an enhancement to a subscription or other service. Consequently, a user may enter a message containing one or more shortcuts defined by the user. The present system converts the shortcuts to text equivalents. The recipient of the message receives the message with text equivalents. The present system converts the message with text equivalents to a message comprising shortcuts defined by the recipient.

The present system operating on a server cluster allows a user to maximize the amount of information transmitted via SMS. A user sends a message comprising shortcuts to a recipient using a service such as an Internet service provider. The message with one or more shortcuts is transmitted via SMS to the Internet service provider. The present system replaces the one or more shortcuts with text equivalents as defined by the user before sending the message to the recipient. The present system then replaces words or phrases in the message with one or more shortcuts, as defined by the message recipient before final delivery to the recipient. In this manner, messages customized with personal shortcuts are transmitted with fewer characters. Both the sender and recipient of the message view the message with their own shortcuts.

The present system requires fewer keystrokes by the user to enter messages while still sending a coherent message. The ability to use fewer keystrokes for message entry is especially useful for devices with small keyboards or other entry devices.

The present system reduces the skill required to enter messages by allowing a user to define shortcuts requiring fewer letters for words or phrases. For example, a user may define a shortcut “ttyl” for the phrase “talk to you later”, replacing a text string of 17 letters with a shortcut of four letters.

The present system allows the user to maximize the use of small viewing screens, replacing longer text strings with shortcuts defined by the user. Consequently, the user is not required to scroll as much (if at all) to read a message.

The present system comprises a profile table, a shortcut table, and a shortcut/profile lookup table that are stored as metadata on a device used to send messages such as a mobile communications device, a desktop personal computer, etc. In one embodiment, the profile table, the shortcut table, and the shortcut/profile lookup table are stored as metadata on a server used to send and receive messages.

The profile table comprises profiles entered and defined by the user. The profiles are selected by the user to define groups of shortcuts used by the profile in sending and receiving messages. The shortcut table comprises shortcuts (character strings) used by the present system to substitute for text equivalents (words or phrases) in a message. The user defines a shortcut and text equivalent for the shortcut and then associates the shortcut with one or more profiles. For example, a user may define a shortcut as “l8r” with a text equivalent of “later” and assign this shortcut to profiles “friends” and “family” but not “work”.

The shortcut/profile lookup table is generated by the present system to look up profiles assigned to a particular shortcut found in a message. The present system also uses the shortcut/profile lookup table to find a set of shortcuts associated with a particular profile.

The present system further comprises a parser, an optional smart parser, and a buffer. The parser separates an outgoing message into segments comprising shortcuts. The present system identifies the shortcuts in the message and replaces the shortcuts with text equivalents such as words or phrases.

In an optional process, the optional smart processor separates an incoming message into segments such as words or phrases. The optional smart processor compares the words or phrases with text equivalents in the shortcut table and replaces the words or phrases in the message with shortcuts for display to the user.

In one embodiment, a device equipped with the present system can be supplied with a database of shortcuts and profiles that can be customized and edited by the user. In a further embodiment, the present system can support shortcuts for additional languages. In this embodiment, the present system stores a multi-character set in metadata and maps shortcuts to words or phrases in additional languages. In such an embodiment, a language translator will be embedded in the system to facilitate translation of the messages to the recipient's desired language.

In a further embodiment, the present invention is a computer program product for customizing an incoming text message, the computer program product comprising a computer-readable storage medium having computer-readable program code portions stored therein, the computer-readable program code portions including a plurality of executable instruction codes comprising: a first set of instruction codes for receiving the incoming text message; associating the incoming text message with at least one of a plurality of shortcut profiles each of which is stored in a profile table; storing at least one shortcut in a shortcut table and associating the at least one shortcut with an equivalent text, an equivalent text word count and a shortcut identifier; assigning a profile code to and associating the shortcut identifier with at least one of the plurality of shortcut profiles; if parsing is enabled, a second set of instruction codes parses the received incoming text message into a plurality of individual character strings; a third set of instruction codes for selectively replacing at least one of the individual character strings with a corresponding equivalent shortcut in relation to the at least one of the plurality of shortcut profiles to produce a shortcut message; and a fourth set of instruction codes for presenting the shortcut message

The present invention may be embodied in a utility program such as a customized messaging utility program. The present invention provides means for the user to identify a set of profiles, a set of shortcut character strings, a text equivalent for each of the shortcut character strings, and an association between the set of profiles and the set of shortcut character strings for each of the shortcut character strings. The present invention further provides means for a user to select a profile for use by the present system. After entering a message, a user invokes the customized messaging utility to replace at least some of the shortcut character strings in the message with a corresponding text equivalent according to the selected profile. Upon receipt of a message, the customized messaging utility replaces any of the words or phrases in the message that match a text equivalent with a shortcut character string associated with the text equivalent according to the selected profile.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a customized messaging system of the present invention can be used;

FIG. 2 is a block diagram representing the high-level architecture of the customized text messaging system of FIG. 1 operating on a customized messaging client;

FIG. 3 is comprised of FIGS. 3A, 3B, and 3C, and represents a process flow chart illustrating a method of operation of the customized messaging system of FIGS. 1 and 2 in sending a message;

FIG. 4 is comprised of FIGS. 4A, 4B, and 4C, and represents a process flow chart illustrating a method of operation of the customized messaging system of FIGS. 1 and 2 in receiving a message;

FIG. 5 is a diagram illustrating a user interface for enabling the customized messaging system of FIGS. 1 and 2;

FIG. 6 is a diagram illustrating a user interface for manipulating a set of user-defined, customized profiles used by the customized messaging system of FIGS. 1 and 2;

FIG. 7 is a diagram illustrating a user interface for manipulating a set of user-defined, customized shortcuts used by the customized messaging system of FIGS. 1 and 2;

FIG. 8 is a block diagram illustrating a high-level hierarchy of one embodiment of the customized messaging system of FIG. 1 operating on a customized messaging server cluster;

FIG. 9 is comprised of FIGS. 9A, 9B, and 9C, and represents a process flow chart illustrating a method of operation of the customized messaging system of FIGS. 1 and 8 in sending a message; and

FIG. 10 represents a process flow chart illustrating a method of operation of the customized messaging system of FIGS. 1 and 8 in receiving a message.

### DETAILED DESCRIPTION OF PREFERRED EMBODIMENTS

The following definitions and explanations provide background information pertaining to the technical field of the present invention, and are intended to facilitate the understanding of the present invention without limiting its scope:

E-mail (electronic-mail): The transmission of memos and messages over a network. Within an enterprise, users can send mail to a single recipient or broadcast it to additional users. Mail is sent to a simulated mailbox in the network mail server or host computer until it is interrogated and deleted.

Instant Messaging: A computer conference using the keyboard (a keyboard chat) over the Internet between two or more people. Instant messaging (IM) is not a dial-up system like the telephone; it requires that both parties be on-line at the same time.

Internet: A collection of interconnected public and private computer networks that are linked together with routers by a set of standards protocols to form a global, distributed network.

PDA: (Personal Digital Assistant) A handheld computer that serves as an organizer for personal information. It generally includes at least a name and address database, to-do list and note taker. PDAs can use a stylus or thumb keyboard for input to select menu items and to enter printed characters. The unit may also include a small on-screen keyboard that is tapped with the pen. Data are synchronized between the PDA and desktop computer via cable or wireless transmission.

SMS (Short Messaging System or Short Message Service): A feature that allows users to receive or transmit short text messages using a wireless phone. Using SMS, a short alphanumeric message up to 160 characters can be transmitted to a mobile phone that displays the message in a manner similar to a pager.

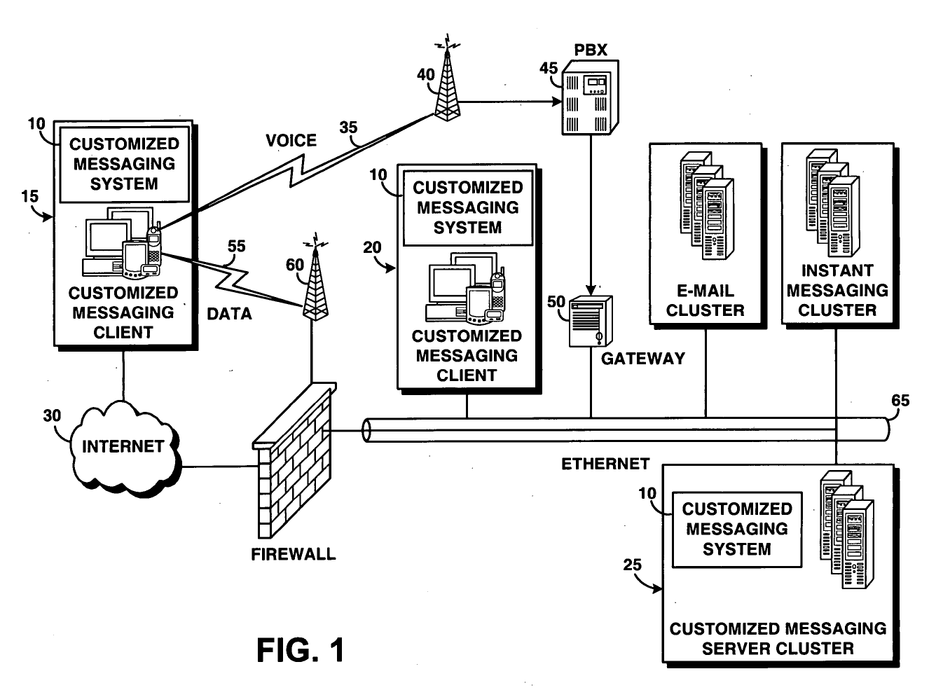

FIG. 1 portrays an exemplary overall environment in which a system and method for facilitating customization of text messaging using mobile devices (the “system 10”) according to the present invention may be used. System 10 includes a software programming code or computer program product that is typically embedded within, or installed on a computer, workstation, laptop, PDA or other wireless handheld device, cell phones, etc., as represented by a customized messaging client 15 and a customized messaging client 20. The customized messaging client 15 is represented herein, for illustration purpose only, as a wireless device, while the customized messaging client 20 is represented as a computer, workstation, etc.

The function performed by system 10 can be implemented in a server-side system such as a customized messaging server cluster 25. System 10 can also be added to any instant messaging application to extend the function of the instant messaging application to comprise customized messaging, or alternatively, system 10 can implemented separately. System 10 can be saved on a suitable storage medium such as a diskette, a CD, a hard drive, or like devices.

The customized messaging client 15 communicates with other computers or networks of computers through various paths: Internet 30; wireless communication as represented by a voice transmission 35 through an antenna 40, a PBX 45, and a gateway 50; or a data transmission 55 through an antenna 60 and Internet 30 or an Ethernet 65. The customized messaging client 20 may also be associated with such other computers in a Local Area Network (LAN) or a Wide Area Network (WAN) through Ethernet 65.

The message originates at, for example, customized messaging clients 15, 20 using system 10. In one embodiment, the message is deposited at the customized messaging server cluster 25. The message can remain at the customized messaging server cluster 25 until a message recipient retrieves the message.

In one embodiment, system 10 is local to the customized messaging client 15. System 10 allows a user to store, parse, and replace one or more key entry shortcuts (shortcuts) with one or more corresponding text equivalents. A shortcut is a user-defined, customized shortcut defined by a user to replace commonly entered character strings such as words, phrases, number groups, etc. in a message such as, for example, a text message.

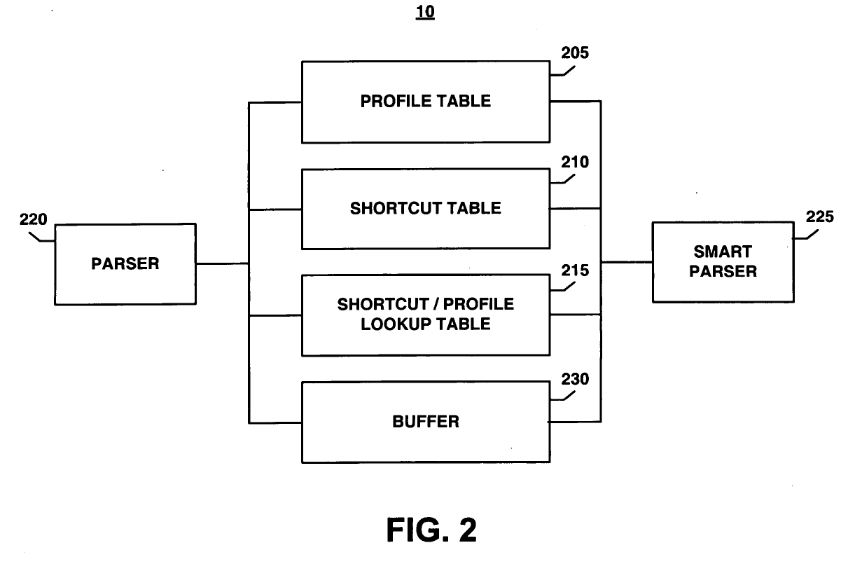

FIG. 2 illustrates a high-level hierarchy of system 10. User-defined shortcuts are stored by system 10 according to one or more shortcut profiles, such as home, work, friends, or a standard. Each of the shortcut profiles is stored in a profile table 205 (e.g., Table 1). The user can define each of the shortcut profiles in the profile table 205; system 10 assigns a profile code to each of the profiles. User-defined shortcuts are stored by system 10 in a shortcut table 210 (e.g., Table 2).

The shortcut table 210 associates the shortcut with an equivalent text, an equivalent text word count (also referenced herein as word count), and a shortcut ID. The shortcut ID is a unique ID assigned to the shortcut by system 10. System 10 associates the shortcut ID with the corresponding a profile code stored in a shortcut/profile lookup table 215.

A parser 220 parses a message entered by the user into character strings, or “words”. Each character string is compared to a set of shortcuts in the shortcut table 210. Shortcuts are then replaced by equivalent text if appropriate for the selected profile. System 10 optionally comprises a smart parser 225. In some embodiments, the parser 220 and the smart parser 225 could be combined as a single parser.

System 10 further comprises a buffer 230. Buffer 230 is initially empty prior to replacing shortcuts with text equivalents for sending a message or replacing text equivalents with shortcuts for receiving a message. As parser 220 parses a message and replaces a shortcut with a text equivalent, the message is appended word-by-word in buffer 230, reconstituting the message with text equivalents as customized by the user.

To customize system 10 for use, a user enters one or more profiles for shortcuts. A user may, for example, enter a profile for use with professional or work-related messages, another profile for use with home or family related messages, and yet another profile for use with messages to friends. Table 1 illustrates an exemplary set of profiles; each profile is assigned a profile code.

TABLE 1
Exemplary profile table 205 comprising user-defined profiles used to
customize performance of System.

| Profile | Profile Code |
|---|---|
| Work | W |
| Home | H |
| Friends | F |

Table 2 illustrates an exemplary shortcut table 210 with shortcuts and text equivalents provided by a user. The user enters a shortcut and a text equivalent for the shortcut. For example, a user enters the letters “bz” as a shortcut and the text equivalent as “busy”. Other shortcuts shown in Table 2 comprise “l8r” for “later”, “mtg” for “meeting”, “im” for “I am”, “ttyl” for “talk to you later”, etc. System 10 assigns a shortcut ID and determines a word count for the text equivalent associated with each shortcut. The shortcut table 210 is stored as metadata local to a messaging device such as customized messaging client 15 (a mobile messaging device) or the customized messaging client 20 (a desktop computer).

TABLE 2
An exemplary shortcut table 210 for use by system 10 listing
exemplary user-defined, customized shortcuts with text equivalents.

| Shortcut ID | Text Equivalent | Shortcut | Word Count |
|---|---|---|---|
| 1 | Busy | bz | 1 |
| 2 | Later | l8r | 1 |
| 3 | Meeting | mtg | 1 |
| 4 | I am | im | 2 |
| 5 | talk to you later | ttyl | 4 |

Table 3 illustrates an exemplary shortcut/profile lookup table 215. The shortcut/profile lookup table 215 relates one or more profile codes with the shortcut ID for each shortcut provided by the user. In the example of table 3, the user has associated the shortcut “bz” with a work profile and a family profile, as shown by the first two lines in table 3; i.e., shortcut ID “1” (shortcut “bz” in table 2) is associated with profile code “W” (profile “work” in table 1) and with profile code “F” (profile “family” in table 1).

TABLE 3
An exemplary shortcut/profile lookup table 215 for use by system
10 with exemplary profile codes and associated shortcut IDs for
user-provided, customized shortcuts and profiles.

| Profile Code | Shortcut ID |
|---|---|
| W | 1 |
| F | 1 |
| F | 2 |
| H | 2 |
| W | 2 |
| W | 3 |
| F | 4 |
| H | 4 |
| W | 4 |
| H | 5 |
| W | 5 |

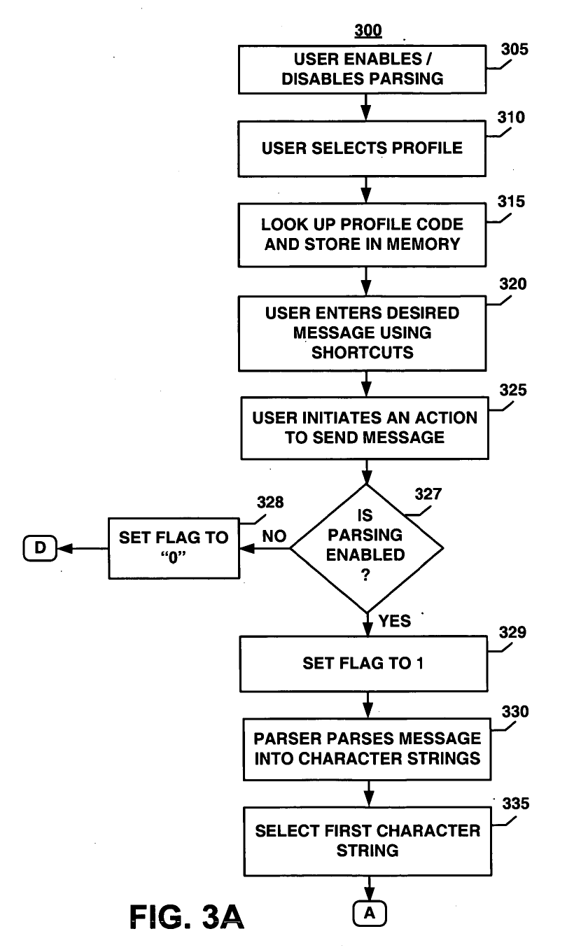

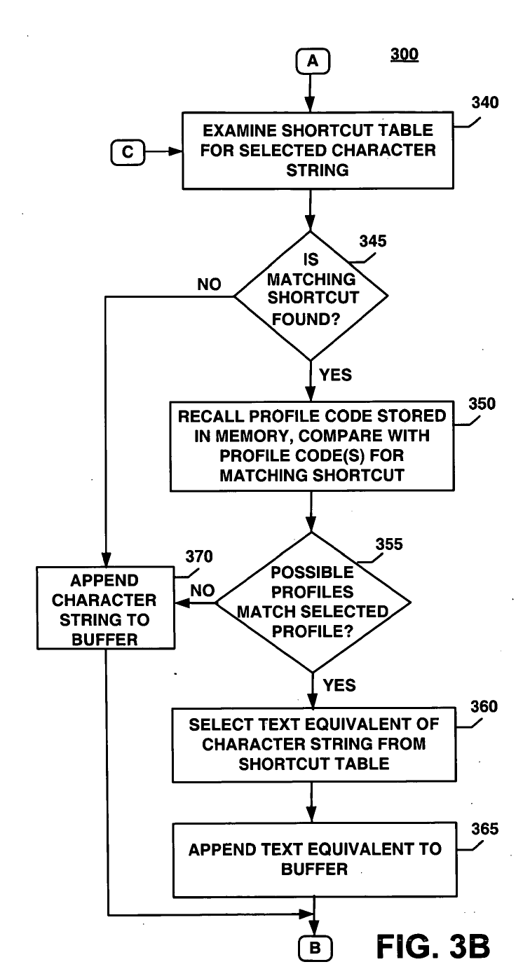

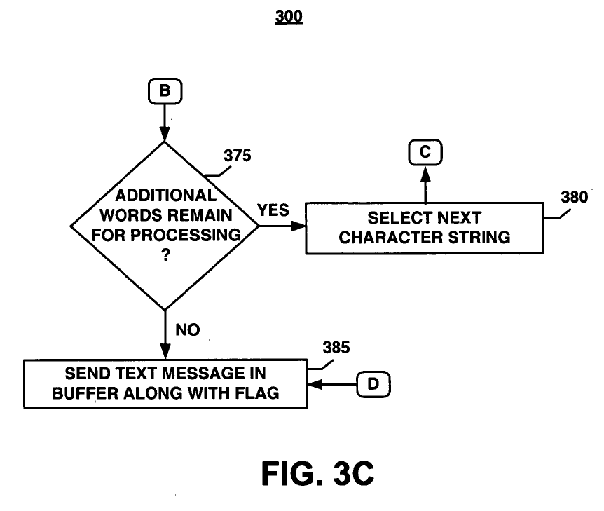

FIG. 3 (FIGS. 3A, 3B, 3C) illustrates a method 300 of system 10 for replacing shortcuts with text equivalents in preparation to the transmission of a message. Prior to entering a message for sending, the user had already entered one or more profiles, and one or more shortcuts with text equivalents, and associated the shortcuts with the profiles in appropriate tables. At step 305, the user is given the choice of either enabling or disabling the parsing feature. At step 310, the user selects a profile for the message. System 10 looks up a corresponding profile code for the profile preference from profile table 205 (e.g., Table 1) and stores the profile code in memory for later use (step 315).

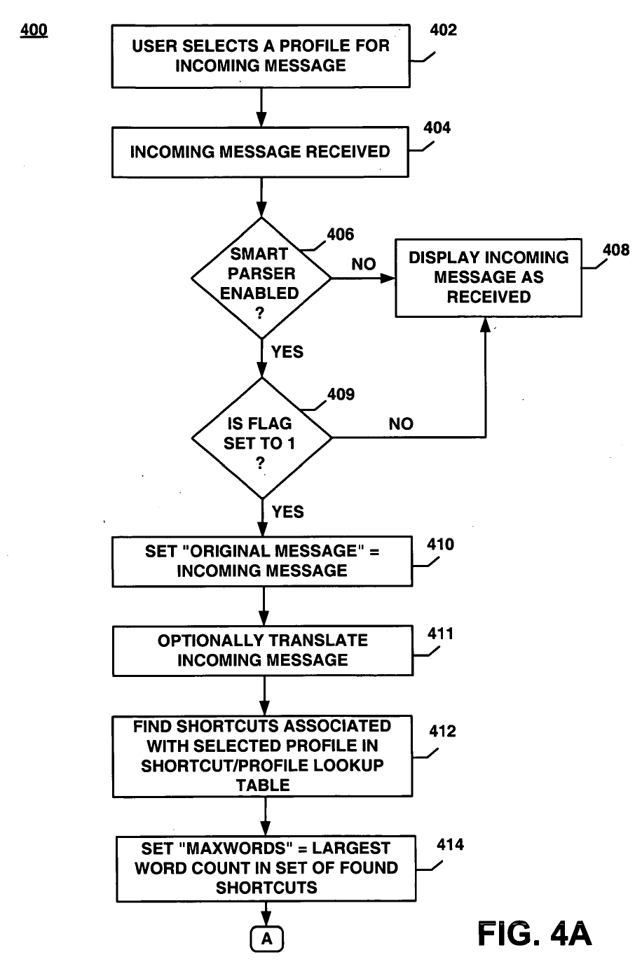

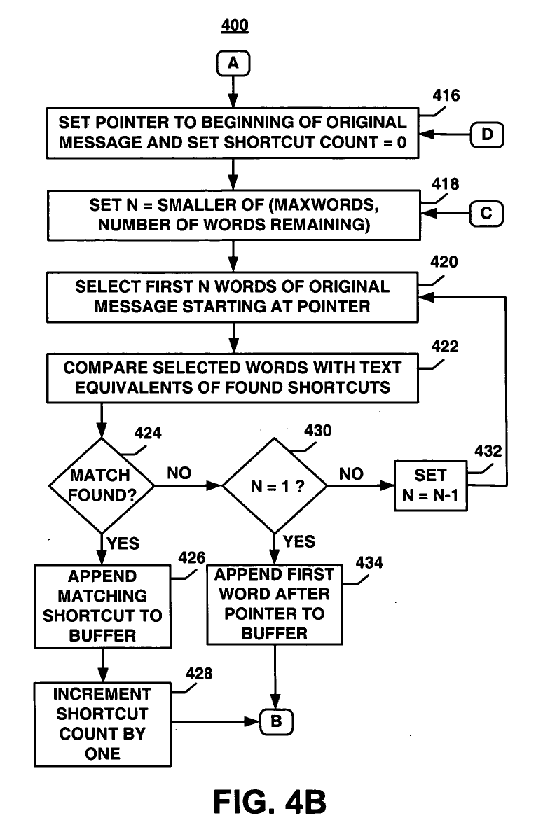

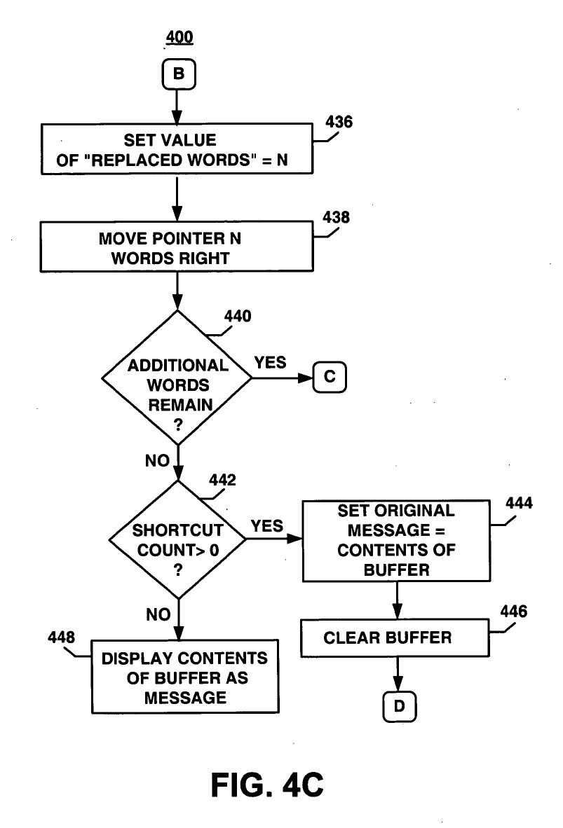

The user enters a message using shortcuts as desired (step 320) and initiates an action to send the message (step 325). At step 327, system 10 inquires whether the parsing feature has been enabled by the user. If the parsing feature has not been enabled, system 10 sets a flag to “0” (step 328) and proceeds to step 385 of FIG. 3C. System 10 then sends the text message from the buffer as is, without parsing, along with the flag (step 385). If, however, system 10 determines at step 327 that the parsing feature has been enabled, it sets a flag to “1” (step 329), and instructs parser 220 to parse the message into character strings such as, for example, words and shortcuts (step 330). When the flag is set to “1”, it means that the user-entered shortcuts have been converted into a full text message. When the flag is set to “0”, it means that the user-entered shortcut message is sent as is. The recipient of the message will examine the flag to determine whether the received message should be further processed, as it will be explained hereafter in connection with FIG. 4. System 10 selects a first character string (step 335) and examines the shortcut table 210 (e.g., Table 2) for the selected character string (step 340).

If a shortcut corresponding to the selected character string is found in the shortcut table 210, e.g., Table 2, (decision step 345, FIG. 3B), a matching shortcut is identified. System 10 recalls the profile code previously stored in memory at step 315 (step 350), looks up the shortcut/profile lookup table to identify all possible profile codes for the shortcut ID, and compares the recalled profile code with all the possible profile codes for the matching shortcut. If possible profiles for the matching shortcut match the recalled profile code (decision step 355), system 10 selects the text equivalent for the character string of the matching shortcut from the shortcut table 210 (step 360). System 10 then appends the text equivalent to buffer 230 (step 365). Buffer 230 is initially empty. The text message is parsed and rebuilt in the buffer “word by word”, with text equivalents replacing shortcuts as customized by the user.

If a character string is not found in the shortcut table 210, e.g., Table 1 (decision step 345), system 10 appends the character string to buffer 230 (step 370). If possible profiles for the shortcut do not match the recalled profile code (decision step 355), system 10 appends the character string to buffer 230 (step 370). If additional character strings remain for processing (decision step 375, FIG. 3C), system 10 selects the next character string in the message (step 380), and repeats step 340 through step 380. When no character strings remain for processing (decision step 375), system 10 transmits the text stored in the buffer along with the flag (step 385).

As an illustration, the user selects the “work” profile as shown in Table 1 (step 310). System 10 looks up the profile code for the “work” profile and stores the profile code “W” in memory (step 315). The user enters the following message (step 320):

“im in mtg ttyl”.

Parser 220 parses the message into character strings “im”, “in”, “mtg”, and “ttyl” (step 330). System 10 examines the shortcut table 210 (e.g., Table 2) for the character string “im” (step 340). The character string “im” is found in the shortcut table 210 with text equivalent “i am” and a shortcut ID of 4. System 10 recalls the stored profile code “W” and compares it with possible profile codes for the shortcut ID of 4 in the shortcut/profile lookup table 215, e.g., Table 3, (step 350). System 10 finds that the “work” profile comprises the shortcut “im” (decision step 355). System 10 then appends the text equivalent “i am” in buffer 230. Buffer 230 is initially empty; after processing the character string “im”, buffer 230 comprises “i am”.

System 10 selects the next character string “in” (step 380) and examines the shortcut table 210 (e.g., Table 2) for the character string “in” (step 340). The character string “in” is not found in the shortcut table 210 (decision step 345). System 10 then appends the character string “in” to buffer 230 (step 370). Buffer 230 now comprises “i am in”.

System 10 continues processing as before with the remaining character strings, generating the message “i am in meeting talk to you later” in buffer 230 to replace “im in mtg ttyl”. System 10 sends the text in buffer 230 as directed by the user (step 385).

FIG. 4 (FIGS. 4A, 4B, 4C) illustrates a method 400 used by system 10 to receive a message. At some time prior to receiving a message, the user selects a profile for incoming messages (step 402). In one embodiment, the same profile is applied to incoming and outgoing messages. Buffer 230 is empty. In one embodiment, separate buffers are provided for incoming messages and for outgoing messages. A device such as, for example, the customized messaging client 15 receives an incoming message (step 404). System 10 determines whether the smart parser 225 is enabled (decision step 406). If the smart parser 225 is not enabled, system 10 displays the incoming message as received (step 408).

If the smart parser 225 is enabled (decision step 406), system 10 checks to see if the message was sent in full text form, i.e., flag=1, or whether it was sent in shortcut form, i.e., flag=0 (step 409). If the flag is not set to “1”, then the message is displayed as it was received in step 408. Otherwise, if the flag is set to “1”, system 10 sets a variable “Original Message” equal to the incoming message (step 410). At step 411, system 10 may optionally process the incoming message by, for example, translating it to a different language of choice, or changing the text color or font size, per user preferences. System 10 finds in the shortcut/profile lookup table 215 (e.g., Table 3) a set of shortcuts associated with the selected profile for incoming messages (step 412); this set of shortcuts is referenced as found shortcuts. System 10 sets a variable “MaxWords” equal to the largest word count in the found shortcuts (step 414), as shown in the shortcut table 210 (e.g., Table 2). For example, in the exemplary shortcut table 210, the largest word count for shortcuts associated with the “work” profile is 4, for the text equivalent “talk to you later”.

System 10 sets a pointer to the beginning of the text string in Original Message and sets a shortcut counter equal to zero (step 416, FIG. 4B). The pointer shows the smart parser 225 where in the incoming message parsing is being performed. System 10 sets a counter, N, equal to the smaller of MaxWords or the number of words remaining in the variable Original Message (step 418). The smart parser 225 selects the first N words in the variable Original Message (referenced as the selected words), starting from the location of the pointer (step 420). The smart parser 225 compares the selected words with the text equivalents of the found shortcuts (step 422). If a match is found between the selected words and any of the found shortcuts (decision step 424), system 10 appends the matching shortcut to the buffer 230 (step 426). System 10 increments the variable Shortcut Count by 1 (step 428).

If no match is found for the selected N words, system 10 checks whether N is equal to one (decision step 430). If not, system 10 decrements N by one and repeats steps 420 through 430, comparing a shorter selection of words from the incoming message with the found list of shortcuts. If N has been decremented to one without the smart parser 225 finding a match in the found shortcuts (decision step 430), no equivalent shortcut exists for the first word after the pointer in the variable Original Message. The smart parser 225 then appends the first word after the pointer in the variable Original Message to the buffer (step 434).

System 10 sets the value of a variable Replaced Words equal to N (step 436, FIG. 4C), and moves the pointer N additional words to the right (step 438). System 10 determines whether any additional words remain in the variable Original Message (decision step 440). If yes, system 10 returns to step 418 and repeats steps 418 to 440 until no additional words remain in the variable Original Message.

If no additional words remain for parsing in the variable Original Message, system 10 checks whether the Shortcut Count is greater than zero (decision step 442). If yes, at least one set of words was replaced by a shortcut in the processing of the variable Original Message by system 10 executing steps 416 through 442. Replacement by additional shortcuts may be possible in the variable Original Message because the text equivalents in the shortcut table 210 (e.g., Table 2) may comprise shortcuts. System 10 sets the variable Original Message equal to the contents of buffer 230 (step 444), clears buffer 230 (step 446), and returns processing to step 416. System 10 repeats step 416 through step 446 until no shortcuts are found for the variable Original Message (decision step 442). System 10 then displays the contents of the buffer to the user (step 448).

As an example, the customized messaging client receives an incoming message: “I am busy talk to you later”. The user has selected the “work” profile for incoming messages (step 402). Assuming that the smart parser is enabled at step 406 and the flag is set to “1” (step 409), system 10 sets the variable Original Message to the incoming message: “I am busy talk to you later”. System 10 finds shortcuts associated with the work profile in the shortcut/profile lookup table 215 e.g., Table 3 (step 412). These found shortcuts for the exemplary incoming message are shown in Table 4 and Table 5.

TABLE 4
An exemplary set of found shortcuts associated with
the work profile “W”.

| Profile Code | Shortcut ID |
|---|---|
| W | 1 |
| W | 2 |
| W | 3 |
| W | 4 |
| W | 5 |

TABLE 5
An exemplary shortcut table 210 comprising the found set of
shortcuts associated with the work profile “W”.

| Shortcut ID | Text Equivalent | Shortcut | Word Count |
|---|---|---|---|
| 1 | Busy | bz | 1 |
| 2 | Later | l8r | 1 |
| 3 | Meeting | mtg | 1 |
| 4 | I am | im | 2 |
| 5 | talk to you later | ttyl | 4 |

The largest word count for the shortcuts listed in Table 5 is 4; system 10 sets the variable MaxWords to 4 (step 414). System 10 sets the pointer to the beginning of the incoming message and sets the shortcut counter to zero (step 416). System 10 sets the counter N to equal the smaller of the value of MaxWords (4) or the number of words remaining in the variable Original Message (7): N=4 (step 418). The smart parser 225 selects the first N=4 words of the Original Message (step 420): “I am busy talk”. The smart parser 225 compares these N=4 words to the text equivalents in the shortcut table 210, e.g., Table 5, (step 422). No matches are found (decision step 424). Consequently, system 10 checks whether N is equal to one (decision step 430). The variable N is 4, so system 10 decrements N to 3 (step 432), and selects the first three words of the incoming message (step 420): “I am busy”.

The smart parser 225 compares these N=3 words to the text equivalents in the shortcut table 210, e.g., Table 5, (step 422) and finds no matches (decision step 424). N is not equal to 1 (decision step 430), so system 10 decrements N to 2 (step 432) and selects the first two words of the incoming message (step 420): “i am”. The smart parser 225 compares these N=2 words to the text equivalents in the shortcut table 210 (step 422) and finds a match (i.e., “i am”) with shortcut ID 4, (decision step 424). System 10 appends the shortcut “im” for the text equivalent “I am” to the buffer (step 426) and increments the variable Shortcut Count by 1 (step 428).

System 10 sets the value of Replaced Words to 2 (for the number of words replace by the shortcut “im”) (step 436), moves the pointer 2 words to the word “busy” in the Original Message, and repeats the process until no words remain to be processed. System 10 outputs from buffer 230 the phrase “im bz ttyl” as shortcut for the Original Message “I am busy talk to you later”.

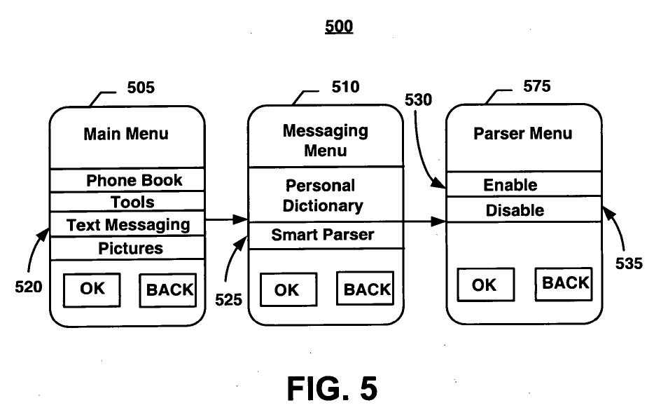

FIG. 5 illustrates an exemplary user interface 500 for enabling system 10. The user interface 500 comprises a Main Menu 505, a Messaging Menu 510, and a Parser Menu 515. The user selects a Text Messaging menu item 520 from the Main Menu 505 to view the Messaging Menu 510. The user selects a Smart Parser menu item 525 to view the Parser Menu 515. The user selects an Enable menu item 530 to enable the smart parser 225 or selects a Disable menu item 535 to disable the smart parser 225.

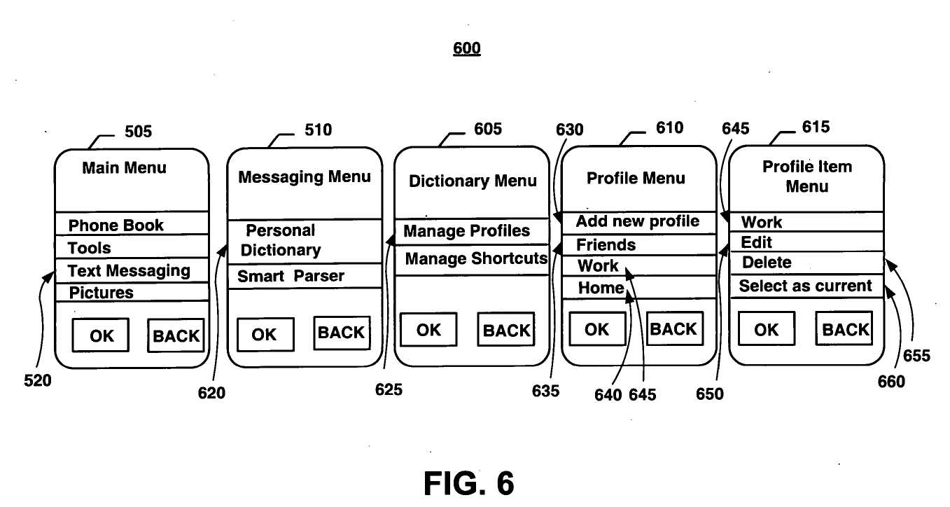

FIG. 6 further illustrates an exemplary user interface 600 for manipulating the user-defined, customized profiles. The user interface 600 comprises the Main Menu 505, the Messaging Menu 510, a Dictionary Menu 605, a Profile Menu 610, and a Profile Item Menu 615. The user selects the Text Messaging menu item 520 on the Main Menu 505 to view the Messaging Menu 510. The user selects a Personal Dictionary menu item 620 on the Messaging Menu 510 to view the Dictionary Menu 605. The user selects a Manage Profiles menu item 625 on the Dictionary Menu 605 to view the Profile Menu 610. On the Profile Menu 610, the user may select an “Add new profile” item 630 to add a new profile to system 10.

The user may select one of the previously entered profiles by selecting a profile name such as, for example, Friends 635, Work 645, or Home 640. By selecting Work 645, the user can view the Profile Item Menu 615 for Work 645. Exemplary functions the user can select are Edit 650, Delete 655, or “Select as current” 660. Edit 650 allows the user to edit a profile displayed in the Profile Item Menu 615 such as, for example, Work 645. Delete 655 allows the user to delete a profile displayed in the Profile Item Menu 615. “Select as current” 660 allows the user to select a profile displayed in the Profile Item Menu 615 as the profile used by system 10 to select text equivalents for shortcuts in outgoing messages and replace text equivalents with shortcuts for incoming messages.

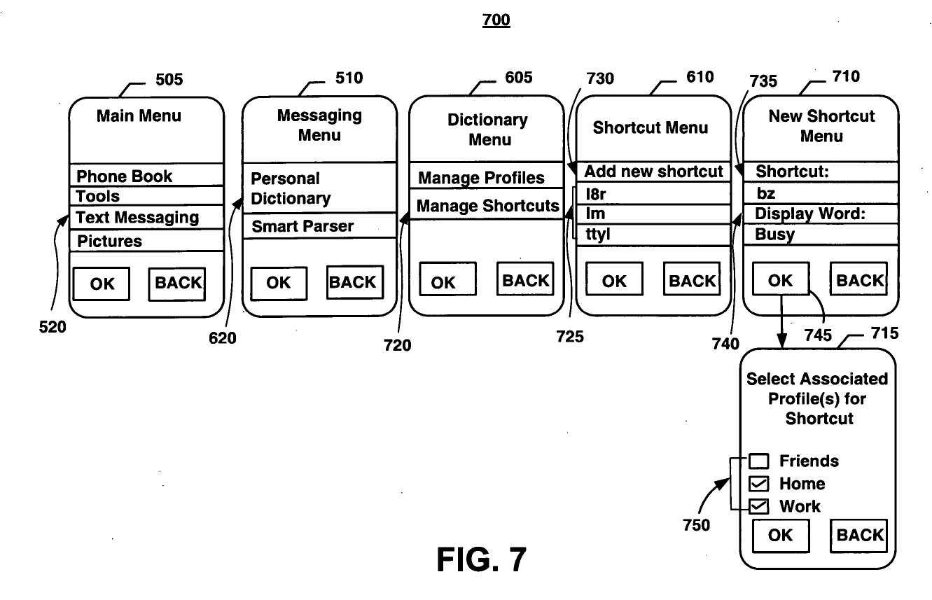

FIG. 7 further illustrates an exemplary user interface 700 for manipulating the user-defined, customized shortcuts. The user interface 700 comprises the Main Menu 505, the Messaging Menu 510, the Dictionary Menu 605, a Shortcut Menu 705, a New Shortcut Menu 710, and a “Select Associated Profile(s) for Shortcut” menu 715.

The user selects the Dictionary Menu 605 as previously presented. The user selects a Manage Shortcuts menu item 720 to view the Shortcut Menu 705. The Shortcut Menu 705 lists shortcuts 725 previously entered by the user. The user may add a new shortcut by selecting an “Add new shortcut” menu item 730. Selecting the “Add new shortcut” menu item 730 allows the user to view the New Shortcut Menu 710. The user may add the shortcut in a field under “Shortcut:” 735. The user may enter the text equivalent for the shortcut in a field under “Display Word:” 740. In the example of FIG. 7, the user has entered “bz” as the “Shortcut:” 735 and “busy” as the text equivalent for the “Display Word:” 740. When the user presses an “OK” button 745 on the New Shortcut Menu 710, system 10 displays the “Select Associated Profile(s) for Shortcut” menu 715. The user may associate the shortcut with one or more profiles by selecting any one or more of the check boxes 750.

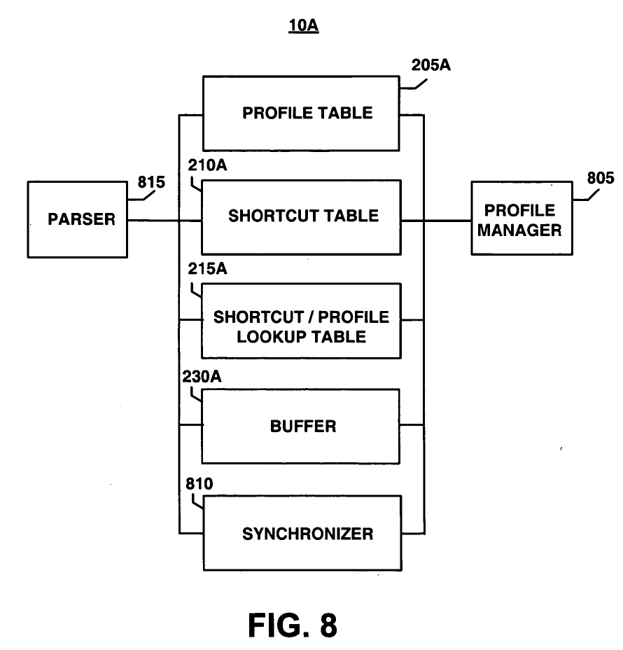

FIG. 8 illustrates a high level hierarchy of one embodiment in which system 10A is installed on a customized messaging server cluster 25. The customized messaging server cluster 25 may be operated by, for example, an Internet service provider and is remote from the customized messaging client 15, 20.

System 10A comprises a profile table 205A, a shortcut table 210A, and a shortcut/profile lookup table 215A, that are similar in content and design to profile table 205, shortcut table 210, and shortcut/profile lookup table 215, respectively.

The contents of profile table 205A, shortcut table 210A, and shortcut/profile lookup table 215A are user-defined and are stored as metadata on the customized messaging server cluster 25 and on the messaging device of the user such as, for example, content messaging client 15, 20. System 10A comprises buffer 230A for storing a message as text equivalents are replaced by shortcuts for incoming messages and for storing a message as shortcuts are replaced by text equivalents for outgoing messages.

System 10A further comprises a web-based profile manager 805 for managing one or more profiles in the profile table 205A and one or more shortcuts in the shortcut table 210A. System 10A also comprises a synchronizer 810 to keep the profiles and the shortcuts stored on the customized messaging server cluster 25 and on the content messaging client 15, 20 synchronized. Further, system 10A comprises a parser 815 that can communicate based on the profile or profiles of the content messaging client 15, 20. The parser 815 can send and receive text messages.

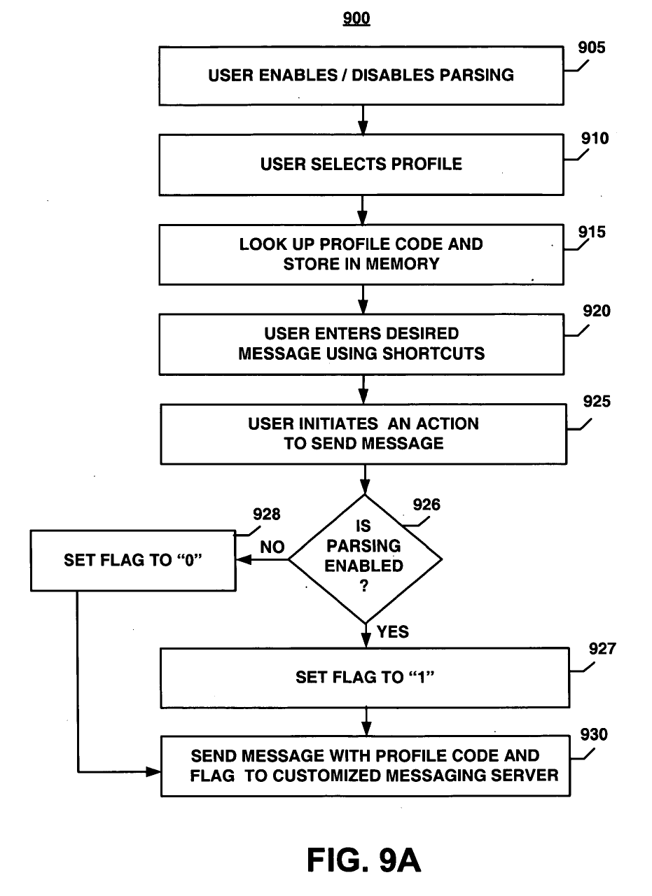

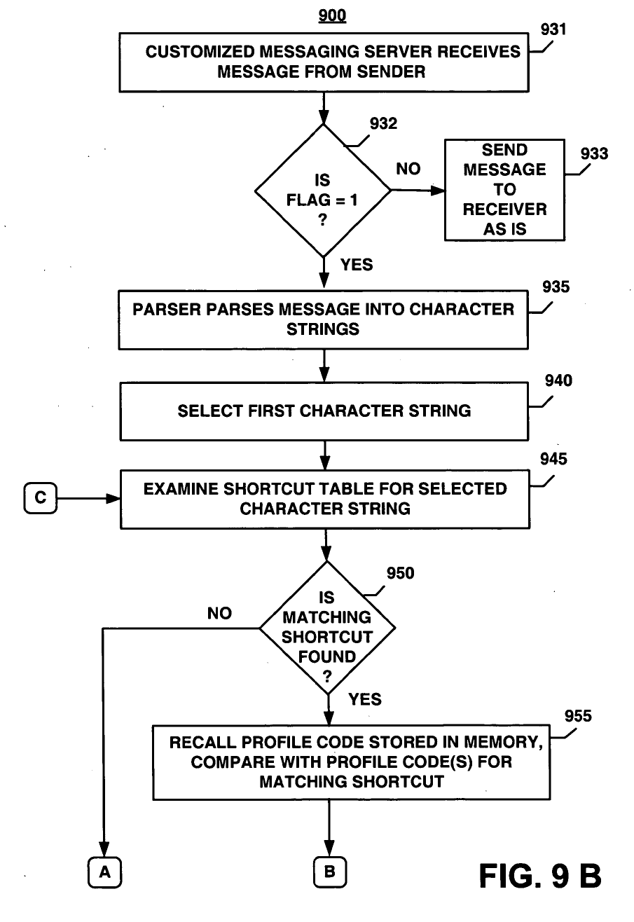

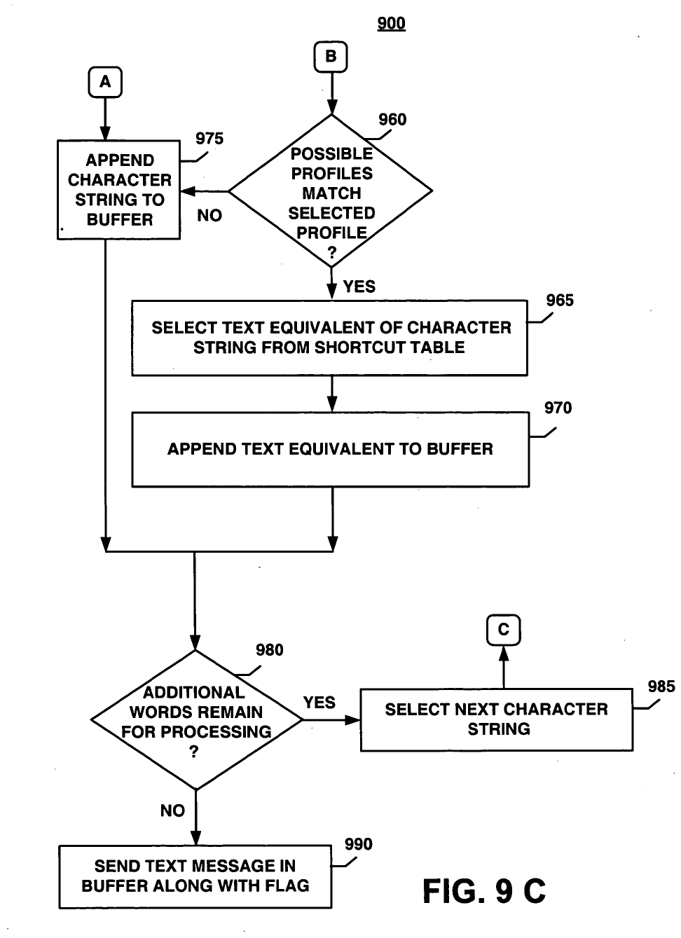

FIG. 9 (FIGS. 9A, 9B, 9C) illustrates a method 900 for use by system 10A to replace shortcuts with text equivalents in a process of sending a message. Method 900 is similar to method 300 of FIG. 3, with the exception that messages are received and transmitted by the customized messaging server cluster 25, as it will be explained later in connection with step 931.

Prior to entering a message for transmission, the user has entered one or more profiles, entered one or more shortcuts with text equivalents, and associated the shortcuts with the profiles. The profiles, shortcuts with text equivalents, and the association between the shortcuts and the profiles are stored as metadata on the messaging device such as, for example, the customized messaging client 15, 20 and the customized messaging server cluster 25.

The user enables/disables parsing (step 905), and selects a profile for the message (step 910). System 10A looks up a corresponding profile code for the profile preference from the profile table 205A and stores the profile code in memory for later use (step 915).

The user enters a message using shortcuts as desired (step 920) and initiates an action to send the message (step 925). System 10A determines in step 926 whether the parsing feature is enabled. If it is, system 10A, sets the flag to “1” (step 927); otherwise, it sets the flag to “0” (step 928). System 10A sends the message along with the flag and the profile selection to the customized messaging server cluster 25 (step 930).

When the message is received at customized messaging server cluster 25 (step 931), system 10A determines if the flag is set to “1” (step 932). If the flag is not set to “1”, the customized messaging server cluster 25 transmits the message as is to the receiver (step 933). Otherwise, if the flag is set to “1”, parser 815 parses the message into character strings such as, for example, words and shortcuts (step 935). System 10A selects a first character string (step 940) and examines the shortcut table 210A for the selected character string (step 945).

If a shortcut corresponding to the selected character string is found in the shortcut table 210A (decision step 950, FIG. 9B), system 10A recalls the profile code previously stored in memory at step 915 and compares the recalled profile code with the profile codes for the matching shortcut (step 955). If possible profiles for the shortcut ID of the identified shortcut comprise the recalled profile code (decision step 960), system 10A selects the text equivalent for the character string of the matching shortcut from the shortcut table 210A (step 965).

System 10A then appends the text equivalent to buffer 230A (step 970). Buffer 230A is initially empty. The text message is parsed and rebuilt in the buffer “word by word”, with text equivalents replacing shortcuts as customized by the user.

If a character string is not found in the shortcut table 210A (decision step 950), system 10A appends the character string to buffer 230A (step 975). If possible profiles for the shortcut do not match the recalled profile code (decision step 960), system 10A appends the character string to buffer 230A (step 975). If additional character strings remain for processing (decision step 980, FIG. 9C), system 10A selects the next character string in the message (step 985), and repeats step 945 through step 985. When no character strings remain for processing (decision step 980), system 10A routes the message stored in the buffer 230A to the appropriate recipient (step 990).

As an illustration, the user selects the “work” profile as shown in Table 1 (step 910). System 10A looks up the profile code for the “work” profile and stores the profile code “W” in memory (step 915). The user enters the following message (step 920):

“im in mtg ttyl”.

The user initiates a send action by, for example, pressing a send button (step 930). A messaging device such as, for example, the customized messaging client 15, 20 sends the message to the customized messaging server cluster 25.

Parser 815 parses the message into character strings “im”, “in”, “mtg”, and “ttyl” (step 935). System 10A examines the shortcut table 210A for the character string “im” (step 945). The character string “im” is found in the shortcut table 210A with text equivalent “i am” and a shortcut ID of 4. System 10A compares the profile code “W” with possible profile codes for the shortcut ID of 4 in the shortcut/profile lookup table 215A (step 955). System 10A finds that the work profile comprises the shortcut “im” (decision step 960). System 10A then appends the text equivalent “i am” in buffer 230A (step 970). Buffer 230A is initially empty; after processing the character string “im”, buffer 230A comprises “i am”.

System 10A selects the next character string “in” (step 985) and examines the shortcut table 210A for the character string “in” (step 945). The character string “in” is not found in the shortcut table 210A (decision step 950). System 10A then appends the character string “in” to buffer 230A (step 975). Buffer 230A now comprises “i am in”.

System 10A continues processing as before with the remaining character strings, generating the message “i am in meeting talk to you later” in buffer 230 to replace “im in mtg ttyl”. System 10A routes the message in buffer 230 to the appropriate recipient (step 990).

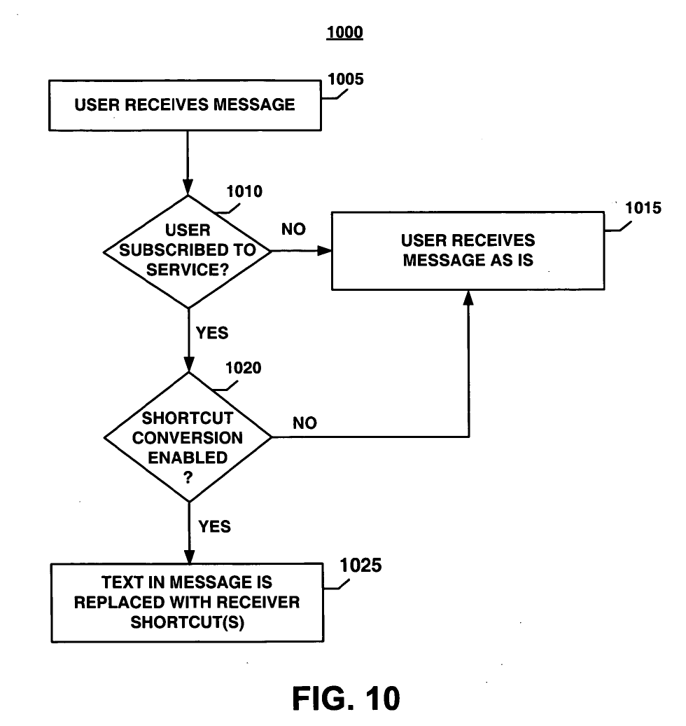

FIG. 10 illustrates an exemplary method 1000 for use by system 10A in receiving messages on the customized messaging server cluster 25. A user receives a message on the customized messaging server cluster 25 (step 1005). System 10 determines whether the user is a subscriber of a service performed by system 10A; i.e., a customized messaging service (decision step 1010). If the user is not a subscriber, the user receives the message without further modification (step 1015). The message may be a full text message (if translated to full text from text with shortcuts by system 10 or system 10A) or may comprise shortcuts used by the message sender.

If the user is a subscriber (decision step 1010), system 10A determines whether the user has enabled shortcut conversion for incoming messages (decision step 1020). If shortcut conversion is not enabled, the user receives the message without further modification (step 1015). As before, the message may be a full text message (if translated to full text from text with shortcuts by system 10 or system 10A) or may comprise shortcuts used by the message sender.

If shortcut conversion is enabled (decision step 1020), system 10 replaces text in the message with appropriate shortcuts (step 1025). An exemplary process for replacing text with shortcuts is presented in method 400, FIG. 4 (FIGS. 4A, 4B, 4C).

It is to be understood that the specific embodiments of the invention that have been described are merely illustrative of certain applications of the principle of the present invention. Numerous modifications may be made to the system, method, and service for facilitating customization of text messaging using mobile devices described herein without departing from the spirit and scope of the present invention. Moreover, while the present invention is described for illustration purpose only in relation to the mobile devices, it should be clear that the invention is applicable as well to, for example, to text messaging performed between any two devices capable of sending and receiving text over any type of text messaging medium such as, for example, instant messaging, e-mail, etc.

The present invention may further be a computer program product for customizing a text message, the computer program product comprising a computer-readable storage medium having computer-readable program code portions stored therein, the computer-readable program code portions including a plurality of executable instruction codes in accordance with one or more embodiments of the present invention.

What is claimed is:

1. A computer program product for customizing an incoming text message, the computer program product comprising a computer-readable storage medium having computer-readable program code portions stored therein, the computer-readable program code portions including a plurality of executable instruction codes comprising:
a first set of instruction codes for receiving the incoming text message;
associating the incoming text message with at least one of a plurality of shortcut profiles each of which is stored in a profile table;
storing at least one shortcut in a shortcut table and associating the at least one shortcut with an equivalent text, an equivalent text word count and a shortcut identifier;
assigning a profile code to and associating the shortcut identifier with at least one of the plurality of shortcut profiles;
if parsing is enabled, a second set of instruction codes parses the received incoming text message into a plurality of individual character strings;
a third set of instruction codes for selectively replacing at least one of the individual character strings with a corresponding equivalent shortcut in relation to the at least one of the plurality of shortcut profiles to produce a shortcut message; and
a fourth set of instruction codes for presenting the shortcut message.

2. The product according to claim 1, wherein if parsing is disabled, a fifth set of instruction codes presents the received incoming text message as is.

3. The product according to claim 1, further comprising a sixth set of instruction codes for setting a flag that accompanies the incoming text message and that indicates whether the message is in shortcut form or full text form.

4. A computer program product for customizing an outgoing text message, the computer program product comprising a computer-readable storage medium having computer-readable program code portions stored therein, the computer-readable program code portions including a plurality of executable instruction codes comprising:
a first set of instruction codes for providing the outgoing text message; associating the incoming text message with at least one of a plurality of shortcut profiles each of which is stored in a profile table;
storing at least one shortcut in a shortcut table and associating the at least one shortcut with an equivalent text, an equivalent text word count and a shortcut identifier;
assigning a profile code to and associating the shortcut identifier with at least one of the plurality of shortcut profiles;
a second set of instruction codes for setting a flag to indicate whether the outgoing text message is in shortcut form or full text form; and
a third set of instruction codes for transmitting the outgoing text message along with the flag.

5. The product according to claim 4, further comprising a fourth set of instruction codes that execute on a server, for processing the outgoing text message based on a receiver's preference.

6. A system for customizing an incoming text message, comprising:
a receiver that receives the incoming text message;
if parsing is enabled, a parser parses the received incoming text message into a plurality of individual character strings;
a modifier that selectively replaces at least one of the individual character strings with at least one equivalent shortcut to produce a shortcut message; and
a display for presenting the shortcut message.

7. The system according to claim 6, wherein if parsing is disabled, the parser does not parse the received incoming text message.

8. The system according to claim 6, further comprising a processor that associates the incoming text message with at least one of a plurality of shortcut profiles.
